(19) United States
(12) Patent Application Publication
(10) Pub. No.: US 2026/0159398 A1
(43) Pub. Date: Jun. 11, 2026

(54) METHOD OF BIOCHAR FORMATION AND MACHINE FOR CONVERSION OF BIOMASS TO BIOCHAR

(71) Applicant: RDA TECHNOLOGIES INC., Halifax, Nova Scotia (CA)

(72) Inventor: Jan Gladki, Sedziszow (PL)

(21) Appl. No.: 18/708,016

(22) PCT Filed: Nov. 8, 2022
(86) PCT No.: PCT/CA2022/051647

§ 371 Date: May 7, 2024

Related U.S. Application Data
(60) Provisional application No. 63/277,524, filed on Nov. 9, 2021.

(51) Int. Cl. C01B 32/324; C01B 32/336; C02F 11/10; C10B 53/00; C10B 53/02

(52) U.S. Cl. CPC C01B 32/324; C01B 32/336; C02F 11/10; C10B 53/00; C10B 53/02

(57) ABSTRACT

There is provided an apparatus for producing activated biochar from an input biomass, the apparatus comprising a metal retort and a metal ceramic retort, each retort being surrounded by a chamber and connected to a biochar activation device. The biomass is introduced into a metal retort and metal ceramic retort, and heated to an average temperature of 300° C. Light-hydrocarbon gasses are extracted from the biomass and collected in the surrounding chamber where they are burned, providing for an automatic carbonization process. The temperature of the exhaust gases in the chamber surrounding the retorts reaches a temperature above 850° C. After the biochar is roasted, it is carried to a biochar activation chamber where it is exposed to the hot exhaust gasses which rapidly heat the biochar and produce activated biochar suitable for a variety of uses. Methods of processing biomass into activated biochar with desirable characteristics are also described.

This application claims priority from U.S. Priority Application No. 63/277,524 filed on Nov. 9, 2021, the contents of which are incorporated herein by reference.

### FIELD OF INVENTION

The present invention relates to a method of and machine for biomass conversion and production of biochar, specifically biochar having high carbon content and low presence of contaminants.

### BACKGROUND OF THE INVENTION

Biomass is obtained through the processing of plants and organic matter, such as trees, plants, fruits, as well as municipal and agricultural waste or sludge. Biomass is generally considered a waste product from a number of industries, but can be converted into biochar, a carbon-rich organic material obtained from the drying and thermal decomposition of biomass at high temperatures in the absence (or near absence) of oxygen.

Biochar has a variety of potential uses. It has been used as a supplement for soil, such as in agriculture, to add nutrients to a soil and enhance crop production. It has also been used as a fuel source, commonly substituted for other solid, carbon-rich fuel sources such as coal.

The basic process for conversion of biomass to biochar is known. The biomass must first typically be dried to reduce the water content, following which the carbon content of the biomass is pyrrolized (also often called torrification or carbonization, though these definitions may also apply to alternative production methods or specific parameters) by heating the material in the absence (or near absence) of oxygen. However, despite the process involving basic principles, the specific application is complex. Variations in the content of the biomass, the temperatures used, the treatment times, and a variety of other factors, all impact the properties of the biochar ultimately obtained. Similarly, the devices to manufacture biochar can vary to achieve the desired biochar output (in terms of desired properties and yield).

The properties of the input biomass can directly affect the resulting production of the desired biochar. Different operation parameters and settings may be required based upon the biomass' ash or moisture content. Similarly, contaminants such as heavy metals in the biomass can contaminate the biochar if not properly handled within the biochar generator.

Biochar can be obtained in a number of different formats classified according to its properties such as relative carbon, ash, and volatile matter content. For example, biochar for the production of graphene commonly requires a carbon content greater than 86%, with ash and volatile matter content less than 6%. Biochar for agricultural soil treatment, in contrast, commonly only requires a carbon content greater than 65%, with an ash content less than 12% and volatile matter content less than 18%.

Biochar formation is typically performed using a biochar reactor. Various biochar reactor designs are known in the art for converting municipal and agricultural biomass into biochar.

Polish patent no. 227338 discloses a method of converting biomass into renewable fuel and a device for converting biomass into renewable fuel. The device for converting biomass into renewable fuel consists of a generator connected to the anaerobic chamber containing a cylindrical retort with a coaxially mounted conveyor shaft having a ploughshare tangent and sliding against the walls of the retort. The generator retort is 5 to 8 m long, and the blade is a blade with a variable pitch. In the chute zone the blade is wound on the conveyor shaft in a counter-clockwise direction. In the retort, from 0.25 m to 0.95 m, there is at least one outlet opening for discharging gaseous products of the reaction, where the sum of the opening area of the outlet openings is not more than 0.8 of the retort opening area. The retort has an insulated hatch at the mouth of the anaerobic chamber.

German utility model DE 20 2011 001 453 U1 (13 Jan. 2011) relates to a device and a recovery process of energy from biomass and combustible waste, as well as for the carbonization of these materials. According to the invention, carbonization takes place in the reactor in an autothermal, anaerobic and continuous pyrolysis process without the addition of water and catalysts. The process is carried out at temperatures above 300° C. The final product, biochar, does not meet the requirements of the UN Convention and European Directives and national regulations.

The Polish patent PL 102 394 describes a device for obtaining charcoal from lignocellulose waste such as sawdust, pits, hard wood chips, nut shells, etc. This device is a multi-zone furnace, constituting a vertical cylindrical retort, the retort being divided by partitions into three zones—casting, glow and cooling. Each of these zones has two chambers. The partitions that divide both the zones and the chambers are double-walled and connected to each other in series. Thus, they form a channel for forced circulation of the heating medium.

The Polish patent PL 204 294 describes a device for autothermal pyrolytic carbonization of biomass and solid waste fuels, in particular for the production of activated carbon, energy and gases. The device consists of tanks for biomass and waste fuels, devices for grinding and segregating input materials, containers for fresh input mix, a horizontally located reactor with a horizontally located cylindrical retort with a screw conveyor connected on one side of the fresh mix reservoir, connecting to a horizontally arranged sealed container for receiving the reaction products. A burner and a fan are located in the horizontally located reactor. A horizontal cylindrical retort has its upper part along its entire length along the chamber of the combustion reactor, openings directed to the upper part of the combustion chamber for the discharge of the gas mixture arising in the retort. This mixture is burned in an anaerobic state.

WO 2015/005807 describes a biochar generator for the production of vegetable and animal-derived biomass. A screw conveyor is used to advance the biomass through a single retort 5-8 m in length. The biomass is torrefied at a temperature of approximately 300° C. for a period of 2-5 minutes, in an anaerobic state, to produce a continuous stream of biochar.

Despite these biochar generator designs being known, they exhibit common problems in biochar processing. Existing biochar generators are limited to periodic operation, with design limitations that prevent continuous input of biomass and/or extraction of biochar. Those that can operate for prolonged periods require temperatures well above the 300° C. pyrolysis temperature, or rely upon hydrothermal carbonization using catalysts. Biochar production using hydrothermal and catalytic methods are becoming increasingly regulated, for example by the United Nations or members of the European Union.

Further, existing biochar generators have insufficient energy efficiency, commonly requiring a greater amount of energy input in comparison to the ultimate product yield. The resulting biochar solid product also contains excessive amounts of toxic elements (cadmium or mercury, as well as other heavy elements), commonly higher than upper limits permitted in the European Union, such as those imposed by EU Regulation 2019/1009.

There is therefore a need in the art for a method and machine for the production of biochar, whereby the biochar is generated for use in agriculture, energy, construction, pharmacology, or cosmetics, with the post-process gases suitable for use in the production of renewable energy. Importantly, there is a need for biochar production done in a continuous mode, without the use of water or catalysts, to allow for a biochar to be obtained with high purity and low levels of contaminants.

### SUMMARY OF THE INVENTION

The present invention relates to a new method for the production of biochar, using a novel biochar generator design and process. Biochar produced in accordance with the invention has beneficial properties, including a low concentration of contaminants, and high yield production in a continuous format.

In one embodiment of the invention, what is provided is an apparatus for the production of activated biochar from biomass, comprising
a generator, having a front portion and rear portion, further comprising a metal retort and a metal-ceramic retort, configured such that biomass can first enter the metal retort and subsequently the metal-ceramic retort, during which it is heated to form roasted biochar
one or more chambers connected to the metal retort, or the metal-ceramic retort, in such a manner that gasses obtained from the biomass can enter the one or more chambers and be heated or burned to form hot exhaust gasses, and
an activation chamber, connected to the generator at the rear portion,
   wherein the activation chamber is configured to receive roasted biochar from the metal-ceramic retort and flow the hot exhaust gasses across the roasted biochar to form activated biochar before the hot exhaust gasses exit the activation chamber.

In another embodiment of the invention, the apparatus further comprises a biomass feeder connected to the generator at the front portion. In a further embodiment of the invention, the apparatus further comprises an activated product cooler connected to the activation chamber.

Various embodiments of the invention permit:
The independent movement of biomass through the metal retort and metal-ceramic retort, including through the use of screw conveyors; and
The independent heating of the metal retort and metal-ceramic retort, including to a range of temperatures along each retort;

In a further embodiment of the invention, the activation chamber comprises a conduit, configured to allow the hot exhaust gasses to be collected after passing over the roasted biochar, including where the hot exhaust gasses can be used to provide heat to portions of the generator, including the metal retort, metal-ceramic retort, or the one or more chambers.

In a further embodiment of the invention, the apparatus is airtight to permit an anaerobic, or near anaerobic, biochar roasting and activation environment.

In another embodiment of the invention, what is provided is a method for producing activated biochar from biomass, comprising
Roasting biomass to an average biomass temperature from 220° C. to 300° C., such that the roasted biomass gives off light-hydrocarbon gasses to form roasted biochar,
Collecting the light-hydrocarbon gasses and further heating or burning the light-hydrocarbon gasses at a temperature of 650° C. to 1100° C. to form hot exhaust gasses; and
Passing the hot exhaust gasses over the roasted biochar to create activated biochar.

Further embodiments of the invention include:
collecting the hot exhaust gasses after they pass over the roasted biochar for use in the production of energy;
activating the roasted biochar with hot exhaust gasses having a temperature of about 850° C.;
roasting the biomass first in a metal retort and subsequently in a metal-ceramic retort;
obtaining biomass from wood processing, fruit and vegetable processing, oil pressing, land management, landscaping, agricultural production, or municipal waste and sludge;
pre-heating the biomass to a temperature of 20° C. to 80° C.;
roasting the biomass for a total duration of 120 to 700 seconds;
collecting the activated biochar and cooling it to a temperature below 40° C.;

Further embodiments of the invention permit the method to be carried out in an anaerobic, or near anaerobic state, and for the continuous production of activated biochar.

### BRIEF DESCRIPTION OF THE DRAWINGS

These and other features of the invention will become more apparent from the following description in which reference is made to the appended drawings herein:

FIG. 1 is a schematic representation of a biochar generator made in accordance with the invention.

FIG. 1a is one embodiment of the schematic representation of FIG. 1, showing the exterior of the biochar generator.

FIG. 2 is a schematic representation of the retort and gas collection chambers inside a biochar generator made in accordance with the invention.

FIG. 2a is one embodiment of the schematic representation of FIG. 2, showing an interior cutaway.

FIG. 3 is a schematic representation of a product activation device, which allows activation of the biochar, made in accordance with the invention. The schematic representation shows two views, a head-on view of the exterior (left) and a cutaway side-view to show an internal configuration.

FIG. 3a is one embodiment of the schematic representation of FIG. 3, showing an interior cutaway.

FIG. 4 is a schematic representation of a biomass feeding device, which allows for the continuous supply and controlled delivery of biomass into the biochar generator, made in accordance with the invention.

FIG. 4a is one embodiment of the schematic representation of FIG. 4, showing an interior cutaway.

### DETAILED DESCRIPTION

One or more illustrative embodiments have been described by way of example. Described herein is a novel method of producing activated biochar and novel biochar generator designs. It should be noted that the differences in embodiments and examples are shown for illustrative purposes to those skilled in the art and are not intended to limit the invention in any way. All references to embodiments, examples, aspects, and the like are intended to be illustrative and non-limiting.

Biomass for use in the invention can be obtained from a variety of potential sources, including through the pressing and squeezing of fruits and vegetables, or the processing and harvesting of trees, plants, fruits and other regrown and segregated raw materials including municipal and agricultural waste and sludge. The biomass may be collected specifically for biochar production, or may be a waste or by-product from a separate process.

According to the invention, pure activated biochar product can be obtained for applications at least in agriculture, energy, construction, pharmacology or cosmetology, with the simultaneous use of post-process gas energy for the production of renewable energy from plant biomass and combustible post-production biomass. In a preferred embodiment, the input biomass is plant biomass (excluding biomass from utility tree), post-production biomass, or segregated municipal biomass waste.

Biochar is produced using a biochar generator, preferable a design according to an aspect of the invention. The biochar generator allows precise control of the desired properties of the resulting biochar despite a wide variety of input biomass sources and properties.

As a general description, the biochar generator has two central retort sections surrounded by an enclosure chamber. The first retort section is made from metal, and the second retort section is made from metal and ceramic. The biomass may be fed into the generator and through the two retort sections using a feed mechanism that allows the feed speed of the material through the generator to be controlled. The generator further includes a biochar activation chamber that is arranged at the end of the biochar generator to receive the roasted biochar, and activates it by exposure to hot exhaust gasses. In a preferred embodiment, the biochar generator can also use the hot exhaust gases to heat the metal retort and metal-ceramic retort, and optionally act as a further energy source.

Detailed description of preferred embodiments of biochar generator designs are now discussed.

### Biochar Generator Design

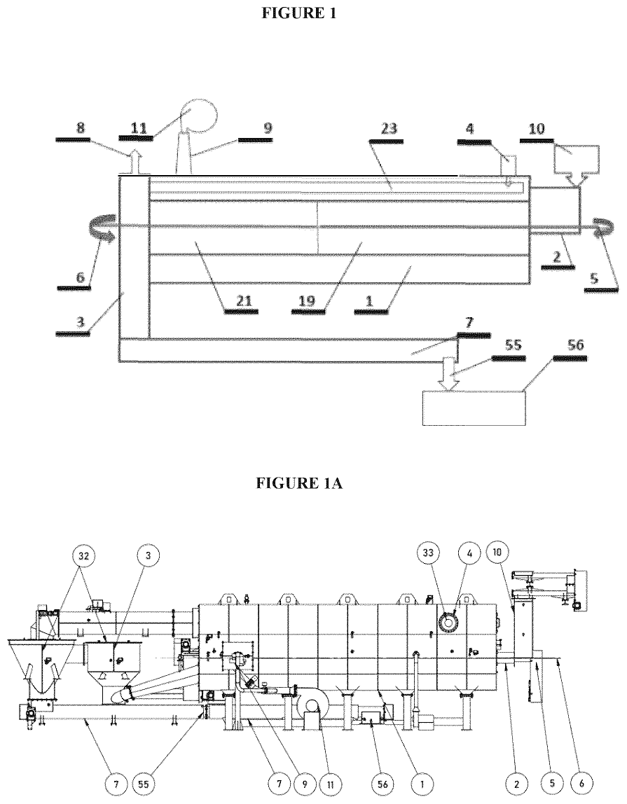

FIGS. 1 and 1a depict a biochar generator comprising a product generator (1), a biomass chamber (2), and a product activation device (3). Biomass is advanced into the product generator by way of a biomass feeder (5), and activated biochar product is moved through the product activation device (3) by a product feeder (6). An activated product cooler (7) is connected between the product activation device (3) and activated product storage tank (56), with a cold activated product feeder (55) aiding in collecting activated biochar for access.

Other components connected to the biochar generator include a combustion device (4) and exhaust port (33) to optionally ignite gasses produced within the product generator, a fan (11) and initiation device (9) to supply air into the system, and a vacuum generating device (8) to aid the flow of air through the biochar generator.

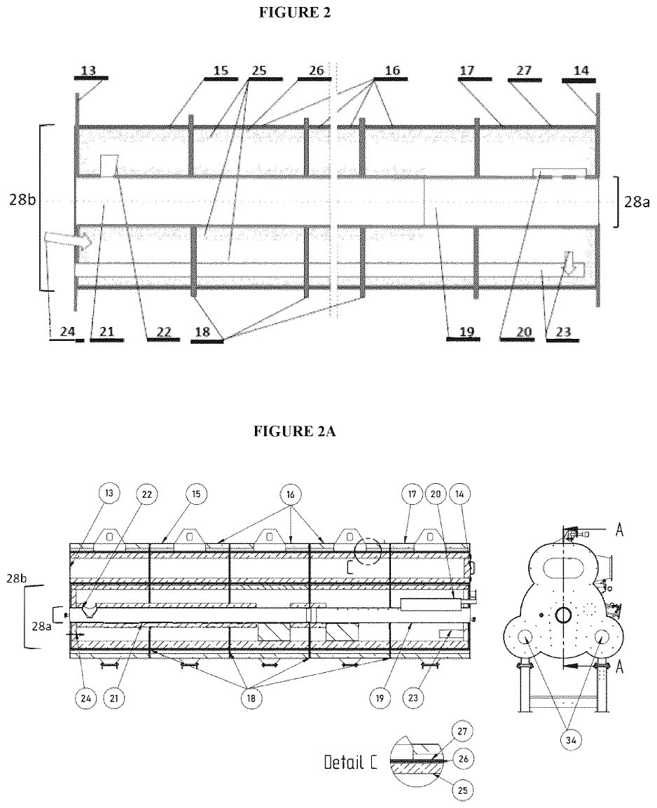

FIGS. 2 and 2a show a cutaway view of the interior of the biochar generator, specifically the product generator (1). The product generator (1) can be divided into two sections, a front section (17) and rear section (15). The product generator (1) may also be divided into intermediate sections using internal divers (18). In a preferred embodiment, each section of the generator comprises a central retort structure, with the front section (17) comprising a metal retort (19) and the rear section (15) comprising a metal-ceramic retort (21). These retorts can be a single retort divided in two sections, or alternatively as two separate retorts coupled together, while still obtaining the benefit of the invention.

The overall size of the generator can be varied by connecting the front section (17) and rear section (15), either by enlarging their size or with the addition of a middle section (16) of variable length. Under either approach, there is a corresponding increase in the length of the metal retort (19) and metal-ceramic retort (21), to provide for an overall desired length of the retort. A moisture outlet (20) is connected to the retort (preferably at the metal retort (19)), allowing for drainage of excess moisture accumulated during the heating of the biomass to the outside of the generator.

In a preferred embodiment, the metal retort (19) and metal-ceramic retort (21) can be heated to independent temperatures, The generator is preferably designed such that the flow of biomass through each retort can be independently controlled. This allows for the roasting of biochar in the metal retort (19), and carbonization in the metal-ceramic retort (21), with each process independently configured and controlled.

The metal retort (19) is preferably made of alloys suitable for use at temperatures up to about 1100° C. The metal-ceramic retort (21) is preferably made of metal-ceramic materials suitable for use at temperatures up to about 1500° C. Metal-ceramic materials may alternatively be described as metal-ceramic composites, ceramic-metal composites, or “cermet.” In a further preferred embodiment, rapid changes in temperature do not affect the materials of the metal retort (19) and metal-ceramic retort (21) which allows for quick changes in biochar production parameters and a correspondingly shorter delay when changing retort temperatures.

In one embodiment, the metal retort (19) and ceramic retort (21) are surrounded by one or more chambers (34) for the collection of air and gasses from the production process. In the preferred embodiment, the generator has two cylindrical chambers, as shown in FIG. 2a. Gasses from the metal-ceramic retort can enter the chambers (34) by an outlet channel (22), located in the rear portion of the product generator (1). The chambers (34) are preferably made up of a metal housing (27), an insulating mat (26) and inner ceramic lining (25).

The chambers (34) further comprise an outlet channel (22) located at the end of the rear section (15), allowing light-hydrocarbon gasses generated from roasting the biomass to exit the metal-ceramic retort (21) and enter into the surrounding chambers which is comprised of a metal housing (27). The chamber preferably comprises an insulating mat (26) containing a ceramic lining (25). The chamber may optionally contain an inlet means (24) and outlet means (23) to facilitate passage of air through the chamber (34), either as part of, or separate to, airflow assisted by the fan (11) and initiation device (9), and the vacuum generating device (8).

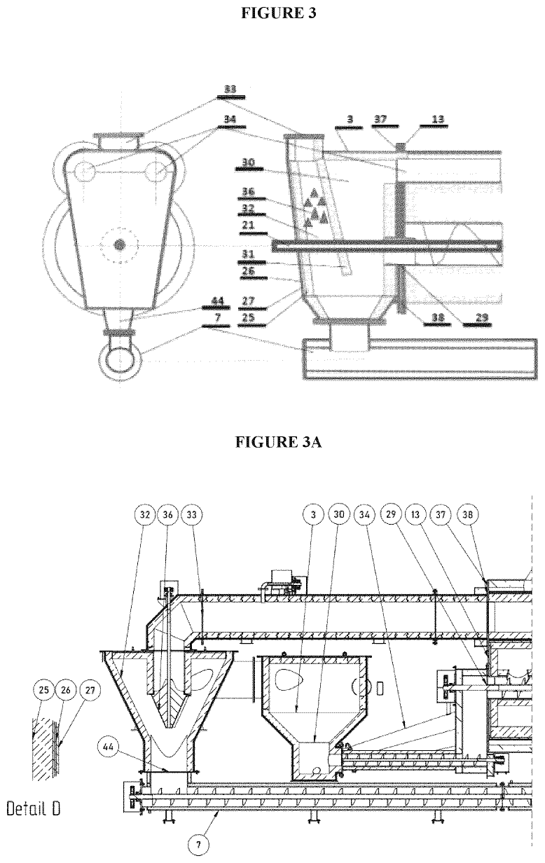

FIGS. 3 and 3a show configurations of the activation chamber (3), which is connected to the rear portion (15) of the generator at the rear wall (13), with an outlet (29) from the product generator provided to receive the heated biochar from the metal-ceramic retort (21). The connection to the rear portion (15) optionally comprises a flange (37), and in the preferred embodiment includes a heat-resistant gasket (38). The activation chamber is preferably comprised of a metal jacket (27) an insulation mat (26) and ceramic lining (25).

The flow of hot exhaust gas from the chamber (34) enters the inner space of the activation chamber (30) in one or more places and passes through the activation chamber and exits into the conduit (33). One or more partitions (31) may direct the flow of the hot gasses through the activation chamber. Shutters (36) can control the flow of gas out the exhaust port to balance the temperature or pressure inside the generator, and to precipitate solids from the exhaust gas reducing the discharge of exhaust particulate. In a further embodiment, the shutters (36) are found in a separate solid particles separation chamber (32).

In a particularly preferred embodiment shown in FIG. 3a, the conduit (33) through which hot exhaust gas flows is connected to the rear portion (15) at the rear wall (13) of the product generator. Through this connection, the hot exhaust gas passes through the conduit and into the product generator (1), optionally passing through heat exchangers (not shown), to aid in heating of the metal retort (19) and/or metal ceramic retort (21), as well as the chamber (34).

In a preferred embodiment, the passage of hot exhaust through the conduit (33) and back into the product generator reduces the heat necessary to be applied to the metal retort (19) and metal-ceramic retort (21), rendering the process more efficient. In a particularly preferred embodiment, this re-capture of heat from the hot exhaust gasses allows for a continual roasting of biomass without the need for a continual application of external heat to the metal retort (19) and metal-ceramic retort (21).

As shown in both FIGS. 3 and 3A, an activated product outlet (44) connects to the activated product cooler (7). As the roasted biochar is moved from the ceramic-metal retort (21) to the product outlet (44), it is heated by the hydrocarbon gasses flowing from the chambers (34) to the conduit (33), creating activated biochar. The activated biochar passes through the product cooler (7), where it is moved by feeders (55 of FIG. 1) to be collected in a storage tank (56 of FIG. 1).

In the preferred embodiment of FIG. 3A, roasted biochar is carried into the activation chamber (30) by a screw feeder. Once in the activation chamber (30) the biochar is activated by the hydrocarbon gasses. This movement of hydrocarbon gasses carries the biochar from the activation chamber (30) through to product outlet (44), where it can then proceed to the product cooler (7).

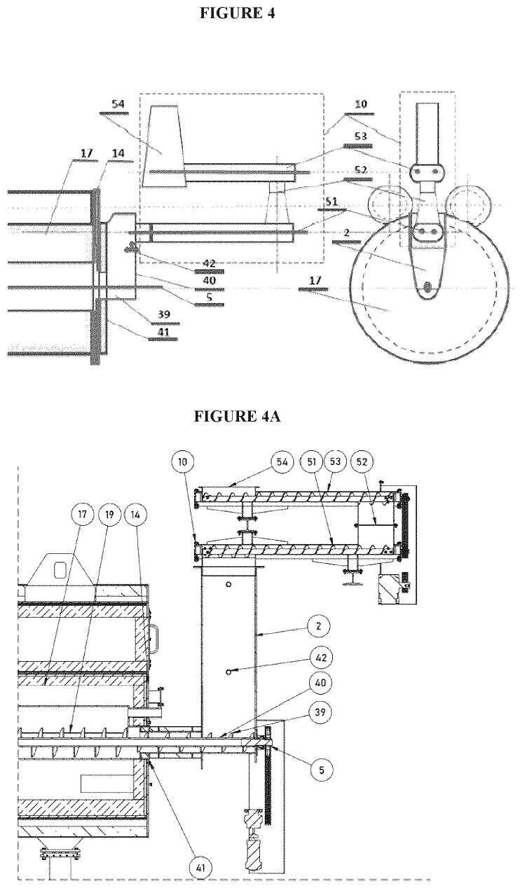

FIGS. 4 and 4a show an optional biomass feeding device (10), connected to the front portion (17) at the front wall (14). In a preferred embodiment of the invention the biomass feeding device (10) allows for the continuous, controlled input of biomass into the biomass chamber (40), continuing into the metal retort (19) using the biomass feeder (5). The biomass feeding device (10) comprises a first biomass input feeder (51), and optionally a second biomass input feeder (53) connected via a biomass transfer connector (52).

As shown in FIG. 4, at a terminal end of the biomass feeding device (10) is a biomass storage tank (54). In a preferred embodiment the biomass storage tank (54) is coupled to the generator at a bottom portion of the biomass chamber (41). In another embodiment, the biomass storage tank (54) provides a direct connection (39) to the feeding mechanism (5) of the retort, through which biomass can be fed into the generator. In a preferred embodiment, the flow of biomass from the biomass storage tank (54) into the biomass chamber (2) may be monitored by a biomass loading sensor (42), monitoring and allowing for control of the flow of biomass into the generator. In a further preferred embodiment, the biomass loading sensor (42) enables the continuous and controlled input of biomass into the biochar generator via the biomass feeding device (10).

As shown in FIG. 4a, in a preferred embodiment the biomass is advanced through the biomass feeding device (10) and into the biochar generator by way of screw feeders located along a central plane (6) of the product generator. In a particularly preferred embodiment, the metal retort (19) and metal-ceramic retort (21) each use a double-shaft, gas tight screw feeder to ensure gas tightness and eliminate air suction into the generator during operation. The use of a gas-tight screw feeder further reduces the risk of gasses reversing from the generator during operation of the generator.

In a further preferred embodiment, the biomass feeding device (10) contains a first biomass feeder (51) and a second biomass feeder (53), each of which are screw feeders with a variable blade pitch, to allow for further control of the desired biomass feed rate while ensuring gas tightness.

The size and configuration of the biochar generator can be varied based upon its intended use. In one embodiment, the orientation of the generator is such that screw-feeders are primarily responsible for the movement of the biomass through the metal retort (19) and the metal-ceramic retort (21), as well as optionally also through the through the product cooler (7). In a preferred embodiment the generator is cylindrical, built around the cylindrical metal retort (19) and cylindrical ceramic-metal retort (21).

The atmosphere within the generator can be controlled, to allow the metal retort (19) and metal-ceramic retort (21) to be held in an anaerobic state (fully or nearly oxygen-free) to facilitate biochar formation, by keeping the biomass feeding device (10) sealed. In a preferred embodiment, this is achieved by configuring the biochar generator with an input supply of CO₂ to eliminate any spark and mitigate any risk of fire. The product cooler (7) and activated product storage tank (56) can similarly be configured to be filled with CO₂. In a particularly preferred embodiment, the biochar generator is designed in a nearly airtight manner, such that the generator does not need a continual supply of CO₂ to maintain an anaerobic state.

In a preferred embodiment, the biomass feeder (5) moves the biomass through the metal retort (19) and metal-ceramic retort (21) in a continuous fashion, for example by a screw-feeder, or other type of conveyer. Activated biochar product is similarly moved continuously through the product cooler (7) to the activate product storage tank (56). This allows for the continuous production of biochar. In a preferred embodiment, the biochar generator design allow for the production of biochar at a rate of up to 250 kg/hour.

In a preferred embodiment, a biochar generator of the within invention can be made into a mobile unit, allowing it to be used in a preferred location, such as in close proximity to the source of input biomass. In a preferred embodiment, mobile generators provide for up to 100 kg per hour of biochar production. This is facilitated through the attachment of the generator to a platform that does not exceed the permissible size for highway traffic. In a preferred embodiment, and mobile biochar generator allows for the production of biochar at a rate of up to 100 kg/hour.

### Production of Biochar

Biochar is produced from a wide variety of biomass products using the novel biochar generator disclosed within. The production of biochar proceeds though the roasting of the input biomass, and the heating (or burning) of light hydrocarbon gasses obtained from the roasting biomass, which are further heated and used to activate the roasted biochar. It will be appreciated that different components of the biochar generator can be heated to varying degrees, such that the desired temperature of the biomass, or of the light-hydrocarbon and exhaust gasses, are obtained. Distinction is therefore made within the embodiments to temperatures of the biomass or gasses themselves, and temperatures applied to portions of the generator.

In one embodiment, the generator is pre-heated such that the temperature applied to the metal retort (19) and metal-ceramic retort (21) is about 500° C. In a preferred embodiment, the temperature of the metal-ceramic retort (21) is higher than that of the metal retort (19). In a further embodiment, the temperature of the retort slowly increases along the length of each retort. In a particularly preferred embodiment, the temperature ranges from about 280° C. at the start of the metal retort (19) gradually up to about 500° C. at the end of the metal-ceramic retort (21). In yet a further embodiment, the temperature of the inner surface of the metal-ceramic retort (21) does not exceed 500° C.

Heating is equally applied to the one or more chambers (34) surrounding each retort, in order to ignite and heat/burn the hydrocarbon gasses that are extracted from the biomass roasting process. The surrounding chamber (34) is heated until it reaches a temperature of at least 650° C. In a preferred embodiment, the overall temperature of the surrounding chamber (34) is about 850° C.-900° C. In a further preferred embodiment, the overall temperature of the surrounding chamber (34) is about 850° C. In any embodiment, the temperature within the surrounding chamber (34) can vary depending on the location, reaching as high as 950° C.-1100° C. at the outlet channel (22).

Once pre-heating of the generator is complete, pre-dried biomass is input into the biomass chamber (2). In a preferred embodiment, the input biomass has a starting temperature of about 20° C., between 20-80° C., or about 80° C. This input biomass temperature can be obtained by heating the biomass before it is fed into the biomass chamber (2), or from heating the biomass chamber (2) containing the biomass until the biomass reaches the desired temperature.

Biomass is fed from the biomass chamber (2) into the metal retort (19) where it is slowly heated and roasted until the biomass reaches an average temperature of about 300° C. This temperature initiates an autothermal biomass roasting/coalization process, generating its own potential source of heat through the production of light hydrocarbon gasses that can be used to activate the biochar and supply heat to the metal retort (19) and metal-ceramic retort (21). To maintain the roasting temperature of the biomass at about 300° C., the inflow of air into the generator can be controlled using the fan (11), as well as adjustments to the rate at which the biomass is moved through the metal retort (19). In a preferred embodiment, the temperature of the biomass does not exceed 300° C. at any point within the metal retort (19), ensuring optimal calcination of the biomass.

A wide variety of biomass can be used to create biochar according to the invention, preferably having a moisture content of no more than about 55% at the time of input. If the moisture content of the biomass is higher than about 55%, it can be pre-dried before being placed in the biomass chamber (40), or pre-dried through heating of the biomass chamber (40). While being roasted in the metal retort (19), moisture that is removed from the biomass can drain out of the generator through the moisture outlet (20).

The roasting of the biomass within the metal retort (19) and metal ceramic retort (21) creates light-hydrocarbon rich gasses, which ignite and burn from contact with the heated internal ceramic inner housing of the generator. These light-hydrocarbon rich gasses become exhaust gasses following heating/burning, and are used for activation of the biochar in the product activation device (3), and optionally for further use in the production of energy, for heating, or for refrigeration.

During operation of the biochar generator, the exhaust gasses are preferably rapidly heated to temperatures above 850° C. These heated gasses subsequently flow from the chamber (34) through the product activation device (3) and out the conduit (33). In doing so, the heated exhaust gasses pass across the roasted biochar as it exits the metal-ceramic retort (21) and passes through the activation device (3), into the activated product outlet (44) and into the product cooler (7). This activates the roasted biochar.

In a preferred embodiment, an average temperature of the light hydrocarbon gasses/exhaust gasses is about 950° C. In a further preferred embodiment, the temperature of the light-hydrocarbon gasses/exhaust gasses varies based upon the location within the generator, with temperature being about 1100° C. shortly after passing through the outlet (22) from the metal-ceramic retort (21), about 950° C. in the generator's inner chamber shortly before entering the activation device (3), and about 850° C. when passing through the conduit (33).

The biomass, when roasted at about 300° C. in the metal retort (19) and metal-ceramic retort (21), will have given off most of its light-hydrocarbon gasses before entering into the product activation device (3). In addition, sulfur oxides and chlorine oxides are released from the biomass during this roasting process.

Upon being exposed to the hot gasses in the activation chamber (30), some pollutants, including heavy elements with a boiling point lower than 850° C., are gasified and exhausted along with the exhaust gasses. This rapid heating causes the roasted biochar to reach temperatures in excess of 800° C., preferably about 850° C., which causes the development of internal surfaces, including channels and pores, creating an activated biochar product. This activation process further causes toxic elements such as cadmium, mercury, and other contaminants to be removed from the activated biochar.

In one embodiment, after having activated the biochar the hydrocarbon rich gasses are fully burned off as a byproduct, using an attached combustion device (4). In another embodiment, the exhaust gas from the generator flows through product activation device (1), supplying heat to the metal retort (19), metal-ceramic retort (21), and/or chambers (34). This allows for the recovery of heat created by the process, and results in the potential for reduced energy input once the biochar generator reaches operation temperature.

In a preferred embodiment, the light-hydrocarbon rich gasses, after passing through the product activation device (3), are collected for use in the production of energy, generation of heat, or use in refrigeration. In a further preferred embodiment, the biochar generator can be configured such that the gasses are exhausted from the biochar generator and into a separate device to operate turbines or heat water for use in secondary energy production.

The biochar produced by the biochar generator will have a range of particle sizes depending upon the input biomass. However, in a preferred embodiment the biochar roasting and heating process creates activated biochar with particle sizes no larger than 20×20×20 mm. In a further preferred embodiment, the particle sizes are no larger than 15×15×15 mm, and in a particularly preferred embodiment are not larger than 10×10×10 mm.

After rapid heating in the activation device (3), the biochar moves into the product cooler (7), where it is cooled to a temperature below 40° C. In a preferred embodiment, the product cooler (7) is filled with carbon dioxide to extinguish any sparks in the activated product. In a further preferred embodiment, the product cooler (7) is cooled by a surrounding chamber filled with cold water or other refrigerant.

The activated biochar has many beneficial properties. Due to the rapid heating of the roasted biochar in the activation chamber, the biochar has a well-developed internal structure, containing a large number of openings and pores, suitable for use in a variety of products.

The biochar production described above can be operated in a continuous method, with the input of biomass matching the output of activated biochar product, without the need to pause or interrupt the biochar roasting and activation process.

### Preferred Characteristics of the Biochar Generator and Biochar Production

Given the range of potential input biomass and output biochar properties that can be utilized with the invention, there is no single, optimal bioreactor design. The following design examples highlight beneficial properties of the invention, and allow for configuration of a desired biochar generator.

In a preferred embodiment, the heat load condition of the generator's metal retort (19) and metal-ceramic retort (21) should not exceed 300 kW/m³, to provide for proper longevity of the components of the bioreactor. This can be readily accounted for by monitoring the physical properties (namely length and diameter) of the retorts and inner ceramic chamber, as well as the heating parameters found within the generator. While exceeding the heat load of 300 kW/m³ is not believed to be detrimental to the properties of the produced biochar, it is believed to result in a gradual deterioration of the biochar reactor's viability by deforming the shape of the metal retort (19) and/or metal ceramic retort (21).

In a further preferred embodiment, the optimal biochar production parameters are controlled by ensuring a relative relationship of the outside diameter of the retorts (28a), which would be approximately equal for both the metal retort (19) and metal-ceramic retort (21), relative to the internal diameter of the generator (28b). In a preferred embodiment, the ratio of the total inside diameter of the generator (28b) ranges from about 2 to about 2.5 times the outside diameter of the retorts (28a), and more preferably from about 2.1 to about 2.4.

The screw feeder of the generator should be configured and controlled such that it is capable of advancing the biomass through the metal retort (19) and metal-ceramic retort (21) such that the total carbonization time within the two retorts occurs from about 120 s to about 700 s. Control of the carbonization time ensure full roasting of the biochar, independent of the diameter of the retort.

In a preferred embodiment, a biochar generator for biochar production from wood biomass (such as red spruce) having about 15×15×15 mm input particle size and about 25% initial moisture content will have an outer diameter of a ceramic metal retort of 575 mm and an inner diameter of the retort metal (19) and ceramic-metal retort (21) is about 340 mm and their total length is about 12000 mm. The diameter of the inner chamber of the generator is approximately 1300 mm, which gives a ratio of the chamber diameter to the retort diameter of 2.26 (1300 mm/575 mm). The temperature of the metal retort (19) and the ceramic-metal retort (21) gradually increases from about 100° C. at the start of the metal retort (19) to just under 500° C. at the end of the metal-ceramic retort. The biochar is moved through the metal retort (19) and the ceramic-metal retort (21) by a controllable screw feeder, such that the biomass'total residence time in the two retorts is about 650 seconds. In continuous operation, such a structure can generally produce 200 to 330 kg of biochar per hour.

In another preferred embodiment, a biochar generator for the production of biochar from plant biomass (including agricultural residues such as grass) with an input particle size of 10×10×10 mm and about 25% of the initial moisture content will have the outer diameter of the ceramic metal retort 420 mm and the inner diameter of the metal retort (19) and the ceramic metal retort (21) is about 170 mm and the combined length of both retorts is about 10,000 mm. The diameter of the inner chamber of the generator is approximately 1000 mm. Providing a ratio of the chamber diameter to the retort diameter of 2.38 (1000 mm/420 mm). The wall temperature of the metal retort (19) and the ceramic-metal retort (21) slowly increases from about 100° C. to just below 500° C.

The biomass and biochar are moved through the metal retort (19) and the ceramic metal retort (21) by screw conveyors so that the total residence time in the two retorts is approximately 520 seconds. In continuous operation, such a structure can generally produce between 100 and 200 kg of biochar per hour.

In yet another preferred embodiment, a biochar generator designed to produce biochar from plant biomass (such as hemp), with an input particle size of about 10×10×10 mm and about 25% initial moisture content, will have an outer diameter of a ceramic metal retort of about 400 mm. and the internal diameter of the metal retort (19) and the ceramic-metal retort (21) is approximately 150 mm and the combined length of both retorts is approximately 8000 mm. The diameter of the inner chamber of the generator is approximately 850 mm, providing a ratio of the chamber diameter to the retort diameter of 2.2 (850 mm/400 mm). The wall temperature of the metal retort (19) and the ceramic-metal retort (21) slowly increases from about 100° C. to about 500° C. The biochar is moved through the metal retort (19) and the ceramic metal retort (21) through screw conveyors such that the total residence time in the two retorts is approximately 450 seconds. In continuous operation, such a structure can generally produce 25 to 100 kg of biochar per hour

### Examples of Biochar Production Using the Invention

The following examples provide properties for achieving activated biochar from different input biomass sources and qualities, when used in accordance with a biochar generator design as described above.

Preferably, the optimal settings for the biochar can be readily determined by a brief carbonization test to identify, at minimum, the ideal residence time in each retort to obtain the desired biomass temperatures for the given biochar generator design.

### Example 1

Plant biomass is roasted to produce solid, activated biochar having a carbon content great than 80%. This biochar is suitable for use as a natural fertilizer, as a catalyst for clearing water and gases, as an additive for cosmetic products, or for use in construction.

The input biomass has the following properties:
a. Particle size of 2 to 15 mm;
b. Moisture content below about 30%;
c. Ash content below about 2%; and
d. Calorific value greater than 10 MJ/kg.

The input biomass is maintained at a temperature from 20° C. to 80° C., and continuously fed into the biomass feeding device and then into the metal retort. The biomass is held within the metal retort in an anaerobic state for approximately 80 to 170 s (preferably optimized based on the specific particle size of the input biomass), at an average biomass temperature of approximately 220° C.

The input biomass is then advanced into the metal-ceramic retort, and held in an anaerobic state for approximately 360 to 500 seconds at an average biomass temperature of approximately 300° C.

During roasting, light-hydrocarbon gasses are released from the plant biomass and heated/burned to create hot exhaust gasses. After passing through the generator, the biochar obtained as a result of the roasting process is fed to the product activation device, where it is rapidly heated directly by the hot exhaust gases having a temperature of approximately 850° C., flowing from the combustion chambers inside the generator. From there the activated biochar flows to the product cooler. The produced activated biochar is cooled below a temperature of 40° C., and stored in a tank filled with CO₂ to minimize risk of fire.

The resulting activated biochar has the following properties:
a. total moisture content below about 10%;
b. ash content below about 8%;
c. total carbon content above about 80%;
d. sulfur content of about 0.05%;
e. no detectable cadmium content;
f. no detectable mercury content;
g. chlorine content of approximately 0.05%; and
h. calorific value of at least 27 MJ/kg.

### Example 2

Plant biomass is roasted to produce solid, activated biochar with carbon content greater than 90%.

Input biomass is selected from hard deciduous trees, hard remnants of palm oil, or coconut shells, having the following properties:
a. particle size from 2 to 15 mm
b. Moisture content below about 30%;
c. Ash content below about 0.8%; and
d. Calorific value greater than 10.5 MJ/kg.

The input biomass is maintained at a temperature from 20° C. to 80° C., and continuously fed into the biomass feeding device and then into the metal retort. The biomass is held within the metal retort in an anaerobic state for approximately 80 to 170 s (preferably optimized based on the specific particle size of the input biomass), at an average biomass temperature of approximately 220° C.

The input biomass is then advanced into the metal-ceramic retort, and held in an anaerobic state for approximately 450 to 500 seconds at an average biomass temperature of approximately 300° C.

During roasting, light-hydrocarbon gasses are released from the plant biomass and heated/burned to create hot exhaust gasses. After passing through the generator, the biochar obtained as a result of the roasting process is fed to the product activation device where it is rapidly heated directly by the hot exhaust gases having a temperature of approximately 850° C. flowing from the combustion chambers inside the generator. From there the activated biochar flows to the product cooler. The produced activated biochar is cooled below a temperature of 40° C., and stored in a tank filled with CO₂ to minimize risk of fire.

The resulting activated biochar has the following properties:
a. total moisture content below about 5%;
b. ash content below about 2%;
c. total carbon content above about 90%;
d. sulfur content about 0.01%;
e. no detectable cadmium content;
f. no detectable mercury content;
g. chlorine content of approximately 0.01%; and
h. calorific value of at least 30 MJ/kg.

### Example 3

Plant biomass is roasted to provide biochar with an average ash content from about 3% to about 7%. Input biomass is obtained from the squeezing and processing of fruits and vegetable, including soft fractions of oil palms, coconut palms, bamboo leaves, and other similar items, having the following properties:
a. Particle size from 1 to 10 mm;
b. Moisture content below about 30%;
b. Ash content below about 7%; and
c. Calorific value greater than 9 MJ/kg.

The input biomass is maintained at a temperature from 20° C. to 80° C., and continuously fed into the biomass feeding device and then into the metal retort. The biomass is held within the metal retort in an anaerobic state for approximately 100 to 200 seconds (preferably optimized based on the specific particle size of the input biomass), at an average biomass temperature of approximately 220° C.

The input biomass is then advanced into the metal-ceramic retort, and held in an anaerobic state for approximately 300 to 400 seconds such that the biomass reaches a temperature of at least approximately 220° C., and a max of approximately 450° C.

During roasting, light-hydrocarbon gasses are released from the plant biomass and heated/burned to create hot exhaust gasses. After passing through the generator, the biochar obtained as a result of the roasting process is fed to the product activation device where it is rapidly heated directly by the hot exhaust gases having a temperature of approximately 850° C. flowing from the combustion chambers inside the generator. From there the activated biochar flows to the product cooler. The produced activated biochar is cooled below a temperature of 40° C., and stored in a tank filled with CO₂ to minimize risk of fire.

The resulting activated biochar has the following properties:
a. total moisture content below about 8%;
b. ash content below about 20%;
c. total carbon content above about 65%;
d. sulfur content about 0.06%;
e. no detectable cadmium content;
f. no detectable mercury content;
g. chlorine content of approximately 0.06%; and
h. calorific value of at least 24 MJ/kg.

### Example 4

Municipal and agricultural waste or sludge, including manure and leaves, is roasted to obtain an activated biochar with a high proportion of combustible by-products. Input biomass has the following properties:
a. Moisture content below about 30%;
b. Plastic content below about 3.5%
c. Ash content below about 40%; and
d. Calorific value greater than 10 MJ/kg.

The input biomass is maintained at a temperature from 20° C. to 80° C., and continuously fed into the biomass feeding device and then into the metal retort. The biomass is held within the metal retort in an anaerobic state for approximately 80 to 150 seconds (preferably optimized based on the specific particle size of the input biomass), at an average biomass temperature of approximately 220° C.

The input biomass is then advanced into the metal-ceramic retort, and held in an anaerobic state for approximately 250 to 400 seconds such that the biomass reaches a temperature of at least approximately 220° C. and a max of approximately 450° C. (more preferably an average temperature of about 300° C.).

During roasting, light-hydrocarbon gasses are released from the biomass and heated/burned to create hot exhaust gasses. After passing through the generator, the biochar obtained as a result of the roasting process is fed to the product activation device where it is rapidly heated directly by the hot exhaust gases having a temperature of approximately 850° C. flowing from the combustion chambers inside the generator. From there the activated biochar flows to the product cooler. The produced activated biochar is cooled below a temperature of 40° C., and stored in a tank filled with CO₂ to minimize risk of fire.

The resulting activated biochar has the following properties:
a. total moisture content below about 10%;
b. ash content below about 40%;
c. total carbon C content above about 20%;
d. sulfur content below about 0.9%;
e. chlorine content of below about 0.9%; and
f. calorific value of at least 10 MJ/kg.

1. An apparatus for the production of activated biochar from biomass, the apparatus comprising:
i) a product generator, having a front portion and rear portion, the product generator further comprising:
(a) a metal retort and a metal-ceramic retort, configured such that biomass can first enter the metal retort and subsequently enter the metal-ceramic retort, during which the biomass is heated to form roasted biochar; and
(b) one or more chambers connected to the metal retort or the metal-ceramic retort, configured such that gasses obtained when the biomass is heated can enter the one or more chambers and be heated or burned to form hot exhaust gasses, and
ii) an activation chamber, connected to the product generator at the rear portion, wherein the activation chamber is configured to receive roasted biochar from the metal-ceramic retort and provide a flow of hot exhaust gasses across the roasted biochar to form activated biochar.

2. The apparatus of claim 1, further comprising a biomass feeder connected to the product generator at the front portion.

3. The apparatus of claim 1, further comprising an activated product cooler connected to the activation chamber.

4. The apparatus of claim 1, wherein the movement of biomass through the metal retort and metal-ceramic retort can be independently controlled.

5. The apparatus of claim 1, wherein the metal retort and metal-ceramic retort can be independently heated.

6. The apparatus of claim 1, wherein the temperature across the metal retort or metal-ceramic retort can be varied along the length of the retort.

7. The apparatus of claim 1, wherein the biomass is advanced through the metal retort or metal ceramic retort using a screw conveyor.

8. The apparatus of claim 1, wherein the activation chamber further comprises a conduit, configured to allow the hot exhaust gasses to be collected after flowing across the roasted biochar.

9. The apparatus of claim 8, wherein the conduit is configured to allow the hot exhaust gasses to flow back into the product generator to provide heat to the metal retort, the metal-ceramic retort, or the one or more chambers.

10. The apparatus of claim 1, wherein the apparatus is airtight, or nearly airtight.

11. A method for producing activated biochar from biomass comprising:
(a) roasting biomass to an average biomass temperature from 220° C. to 300° C., first in a metal retort and subsequently in a metal-ceramic retort, such that the roasted biomass gives off light-hydrocarbon gasses to form roasted biochar;
(b) collecting the light-hydrocarbon gasses and further heating them to an average temperature of 650° C. to 1100° C. to form hot exhaust gasses; and
(c) passing the hot exhaust gasses over the roasted biochar to create activated biochar.

12. The method of claim 11, further comprising collecting the hot exhaust gasses after they pass over the roasted biochar for use in the production of energy.

13. The method of claim 11, wherein the light hydrocarbon gasses have a temperature of about 850° C. when passing over the roasted biochar.

14. (canceled)

15. The method of claim 11, wherein the biomass is obtained from wood processing, fruit and vegetable processing, oil pressing, land management, landscaping, agricultural production, or municipal waste and sludge.

16. The method of claim 11, wherein the biomass is first heated to a temperature of 20° C. to 80° C.

17. The method of claim 11, wherein the biomass is roasted for a total duration of 120 to 700 seconds.

18. The method of claim 11, further comprising collecting the activated biochar and cooling it to a temperature below 40° C.

19. The method of claim 11, wherein each step is carried out in an anaerobic state.

20. The method of claim 11, wherein there is a continuous supply of biomass and resulting continuous production of activated biochar.
